(19) United States
(12) Patent Application Publication
(10) Pub. No.: US 2009/0076868 A1
(43) Pub. Date: Mar. 19, 2009

(54) Automated Electronic Commerce Data Analyzing and Sales System

(76) Inventors: Wade Malone, Atlanta, GA (US); Tze Ming Ku, Atlanta, GA (US); Stephen Herbst, Atlanta, GA (US); Robert Frohwein, Atlanta, GA (US)

Correspondence Address: MUSKIN & CUSICK LLC, 30 Vine Street, SUITE 6, Lansdale, PA, 19446, US

(21) Appl. No.: 12/104,358

(22) Filed: Apr. 16, 2008

Related U.S. Application Data
(60) Provisional application No. 60/912,666, filed on Apr. 18, 2007.

(51) Int. Cl. G06Q 30/00; G06Q 10/00

(52) U.S. Cl. 705/7; 705/26; 705/1

(57) ABSTRACT

A method, apparatus, and computer readable storage to implement an automated e-commerce monitoring system. Data can be extracted from different e-commerce sites in an inconspicuous manner. The different auction sites can be monitored for arbitrage situations and suspicious sellers or items for sale.

### CROSS REFERENCE TO RELATED APPLICATIONS

This application claims benefit to provisional application 60/912,666, which is incorporated by reference herein in its entirety.

### BACKGROUND OF THE INVENTION

1. Field of the Invention

The present inventive concept is directed to a method, apparatus, and computer readable storage medium to automatically monitor and retrieve relevant data from online auctions, parse and analyze that data to identify particular auctions which may involve particular kinds of conduct.

2. Description of the Related Art

Online auctions and other e-commerce sites online are a major avenue that many companies and individuals currently use to sell their products. Items sold on e-commerce may be undesirable (e.g., used, damaged, counterfeit, etc.)

Buyers on e-commerce site currently rely on feedback from other users in order to determine a seller's reliability. Sellers on e-commerce sites that sell undesirable goods still manage to circumvent the feedback system, for example by continuously opening new accounts once prior accounts have received negative feedback.

What is needed is an improved system that can monitor e-commerce sites and identify which items and sellers may be suspicious so that a user can be more informed before purchasing such goods.

### SUMMARY OF THE INVENTION

It is an aspect of the present inventive concept to provide an apparatus, method, and computer readable storage medium to implement improvements in analyzing data from e-commerce sites.

The above aspects can be obtained by a method that includes (a) robotically ascertaining a first price of a first item on a first e-commerce site and storing the first price in a database; (b) robotically ascertaining a second price of a second item on a second e-commerce site and storing the second price in the database, the second e-commerce site being different than the first e-commerce site, the second item being identical or similar to the first item; (c) comparing the first price and the second price, and determining that the first price is lower than the second price; (d) offering and selling the first item at a selling price to a purchaser, the selling price being higher than the first price; (e) purchasing the first item from the first e-commerce site; and (f) arranging shipment of the first item to the purchaser.

The above aspects can also be obtained by a method that includes (a) automatically visiting a web page; (b) extracting data from the web page and storing the data in a database; (c) waiting an amount of time; and (d) automatically clicking a link on the web page to visit a new web page.

The above aspects can also be obtained by a method that includes (a) receiving an identification of an item; (b) performing a seller identification check; (c) performing an item verification check; and (d) determining a confidence level of the item based on the seller identification check and the item verification check.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present inventive concept, as well as the structure and operation of various embodiments of the present inventive concept, will become apparent and more readily appreciated from the following description of the preferred embodiments, taken in conjunction with the accompanying drawings of which:

FIG. 1 is a block diagram illustrating exemplary components used in a an e-commerce data extracting and analyzing system, according to an embodiment;

FIG. 2A is a flowchart illustrating an exemplary method of identifying an arbitrage situation, according to an embodiment;

FIG. 2B is a flowchart illustrating a first exemplary method of capitalizing upon an arbitrage situation, according to an embodiment;

FIG. 3 is a flowchart illustrating a second exemplary method of capitalizing upon an arbitrage situation, according to an embodiment;

FIG. 4 is a block diagram illustrating a peer to peer market, according to an embodiment;

FIG. 5 is a flowchart illustrated an exemplary method of implementing screen scraping, according to an embodiment;

FIG. 6A is a flowchart illustrating an exemplary method of verifying an item, according to an embodiment;

FIG. 6B is a flowchart illustrating an exemplary method if verifying a seller, according to an embodiment;

### DESCRIPTION OF THE PREFERRED EMBODIMENTS

Reference will now be made in detail to the presently preferred embodiments of the inventive concept, examples of which are illustrated in the accompanying drawings, wherein like reference numerals refer to like elements throughout.

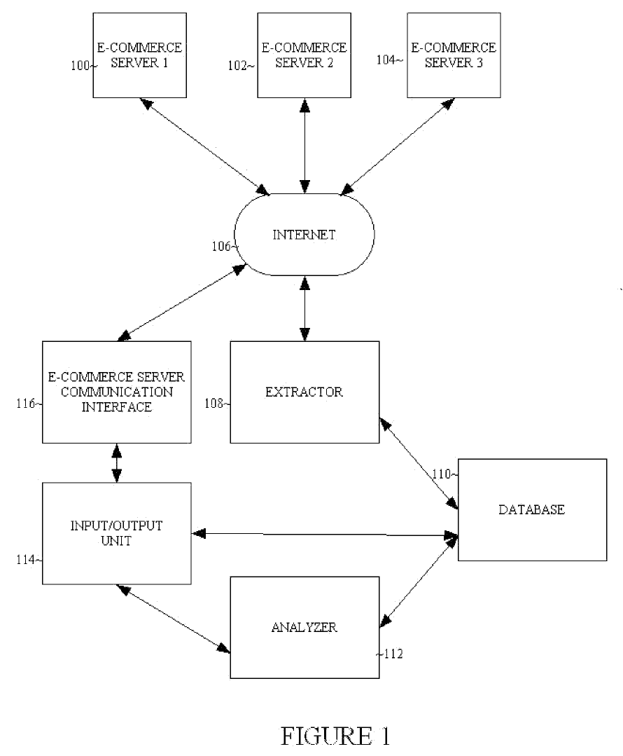

FIG. 1 is a block diagram illustrating exemplary components used in an e-commerce data extracting and analyzing system, according to an embodiment.

E-commerce server 1 100, e-commerce server 2 102, and e-commerce server 3 104 all serve different e-commerce sites which can be an online auction (e.g., E-BAY), an online store (e.g., AMAZON.COM), a services market (e.g., E-LANCE.COM) or any other site in which people can visit using a computer communications network such as the Internet 106 and buy and/or sell products or services.

An extractor 108 is used to automatically visit any combination of the e-commerce sites served by the e-commerce servers. The extractor can comprise a computer which is connected to the internet 106 (or other computer communications network) with a “robot” which can visit web sites automatically. The robot can store URLS of different e-commerce sites and automatically visit these sites by connecting with their respective hosts (or servers) using a computer communications network such as the Internet. Data retrieved from the hosts can be indexed and stored in a database. Data can be stored in numerous ways. For example, the raw screen images can be captured and saved (e.g., in JPG form) for later parsing and analysis. Alternatively, all html data can be saved for later parsing and analysis. Alternatively, the extractor can identify only targeted data (e.g., actual auction summaries) and store the auction summaries in the database 110. The robot browser can “crawl” the auction sites retrieving, indexing, and storing all data it comes across, or only data that is relevant to the user (e.g., by limiting data retrieved to those containing particular keywords, etc.)

Note that methods described herein apply not only to online auction sites but any type of commerce site as well. Thus, “auction data” can also be considered “sales data,” and any information related to a sale on an e-commerce site can be considered sales data. Auction data or sales data included any transactions known to the database, including open auctions or sales offers, close auctions or completed sales, or any other transaction information. The concepts of an auction on an auction site and a sale on an e-commerce site (but not an auction site) can be considered and used interchangeably herein.

An analyzer 112 can retrieve data from the database 110 and analyze the data by applying rules to the data. Rule sets can also be retrieved from the database 110 (or any other storage). The analyzer applies the rules to each individual auction summary. The results of the application determine whether the individual auction summary is flagged (or tagged) with a tag which represents irregular activity. The analyzer can either tag individual auction summaries stored in the database 110 and/or the analyzer can generate a separate list of irregular auctions (which can also be stored in the database 110 or other storage) with associated tags.

An input/output unit 114 can receive data from the analyzer 112 (or rules engine) and/or the database to display data to the user. The user can also identify particular data that the user wishes to view, upon wish the input/output unit 114 can query the database to retrieve the particular data and output the data to the user.

An e-commerce server communication interface 116 can be used to communicate with e-commerce servers. In some cases, e-commerce servers can be contacted to shut down particular offending auctions. The e-commerce server communication interface 116 can communicate with any e-commerce server (e.g., 100, 102, 104, or others) in order to request particular auctions to be shut down. Thus can be done automatically or upon manual request by the user.

It is noted that the components in FIG. 1 are illustrated in one particular arrangement, however it can be appreciated that the operations described herein and the respective hardware used to implement those operations can be arranged in numerous other configurations as well. For example, the entire system can run on a single computer (thus the individual blocks may not actually exist separately) or multiple computers/processors can implement different operations therein. A single database 110 can be used to store any data needed by the system, or multiple databases can be used. Components can be located physically together or in different locations connected by any kind of computer communications network.

With regard to online merchants (or virtually any economic system), there are inefficiencies in the market. An inefficiency can be thought of as where a price of a same item (of very similar item) is not the same at different online merchants. This can also happen in brick and mortar stores as well.

Such situations can be capitalized upon. For example, a party may identify a merchant selling a particular item at $100 and then see buyers at an auction bidding $110 for the same item. The party can then purchase the item at $100 and try to sell it at the auction site for more than the purchase price.

Alternatively, the party does not even need to purchase the item first, but can offer it for sale (by auction or flat price) and once a buyer is found, the item can then be purchased by the party and shipped to the buyer. The item can be shipped directly from the merchant to the buyer, or the item can be shipped from the merchant to the party and then from the party to the buyer.

An automated e-commerce site crawler or “robot” can automatically gather items for sale and automatically determine any disparities in prices between identical or similar items. Once such disparities are identified, then action can be taken based on that information (automatically or manually by a user), in order to capitalize on the disparity.

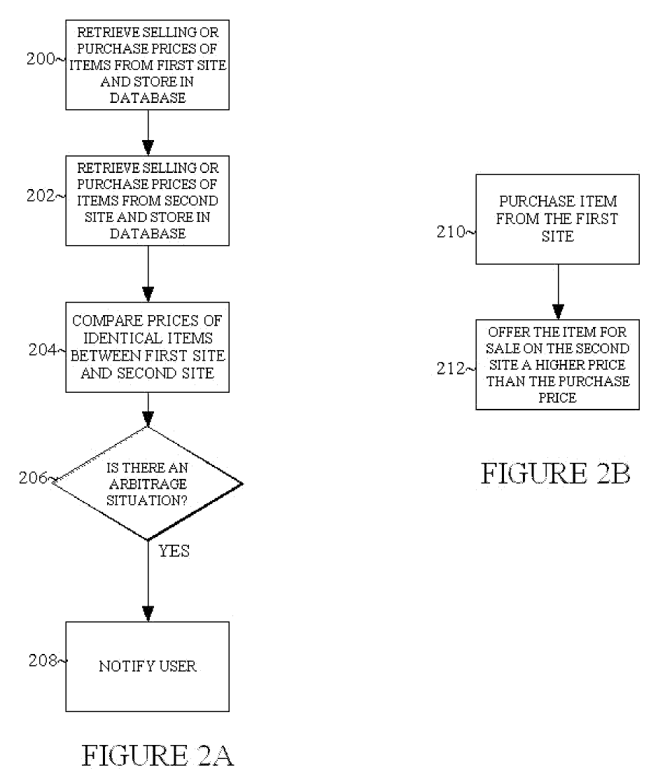

FIG. 2A is a flowchart illustrating an exemplary method of identifying an arbitrage situation, according to an embodiment.

The method can begin with operation 200, which retrieves selling or purchase prices of items from a first site and stores the data in a database. The first site can be any e-commerce site, such as an auction site, online store, etc. The data stored in the database can be the item description, model number or other identifying information, price, etc. The price can either be the currently bid price (if the item is being sold via auction), and/or winning auction price (if the item was being sold at an auction and won), or flat price. If someone wins the action for the item at a particular price it might be indicative that the same item might sell again for the same price on the same auction site.

From operation 200, the method proceeds to operation 202, which retrieves selling or purchase prices of items from a second site and stores the data in a database. The second site can be any e-commerce site, such as an auction site, online store, etc. The data stored in the database can be the item description, model number, or other identifying information, price, etc. The price can either be the currently bid price (if the item is being sold via auction), and/or winning auction price (if the item was being sold at an auction and won), or flat price. If someone wins the action for the item at a particular price it might be indicative that the same item might sell again for the same price on the same auction site.

The retrieving in operation 200 and 202 can be performed by a robot (non-human) which automatically (robotically) crawls e-commerce sites to retrieve data and stores the data in a database.

From operation 202, the method can proceed to operation 204, which compares prices of identical items between the first site and the second site. Items which have different prices are noted.

From operation 204, the method proceeds to operation 206, which determines whether there is an arbitrage situation. This can be performed in numerous ways. For example, if the price differential between the same item at the two different sites is greater than a predetermined threshold (e.g., $10), then the item may be bought and sold at a $10 profit. An arbitrage situation can also be determined according to a predetermined set of rules which is applied to the two identical items at the different prices.

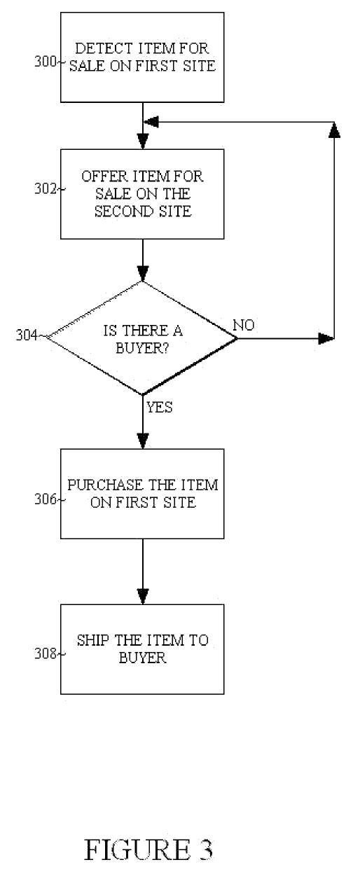

If the determination in operation 206 determines that there is an arbitrage situation, then the user can be notified so that the user can determine what, if any, further action to take (for example, perform the method in FIG. 2B or FIG. 3). Alternatively, the method can automatically take action without human intervention, such as performing the method in either FIG. 2B or FIG. 3.

FIG. 2B is a flowchart illustrating a first exemplary method of capitalizing upon an arbitrage situation, according to an embodiment. This method assumes that the same item is being sold at both sites with the item being sold at a higher price at the second site.

The method can start with operation 210 which purchases the item from the first site. This can be purchased using any method known in the art, such as supplying purchaser data to the first site and payment information.

From operation 210, the method can proceed to operation 212, which offers the item for sale at the second site at a higher price than the purchase price from the first site.

A robot crawler (such as extractor 108) stores the price data it extracts in a database (such as database 110) or databases so that the prices of items being bought and/or sold can be continuous monitored. Thus, an operation of comparing prices between different databases (for example operation 204) can be continuously performed while checking for arbitrage situations. Thus, as soon as prices change on any of the monitored sites, a user can be automatically alerted (or action can be automatically taken) in order to quickly capitalize on such a change.

FIG. 3 is a flowchart illustrating a second exemplary method of capitalizing upon an arbitrage situation, according to an embodiment.

The method can start with operation 300, which detects an item for sale on a first site. This can be done as described herein, typically using robot crawlers which automatically crawl, retrieve, and index information from e-commerce sites.

The method can then proceed to operation 302, which offers the item for sale on the second site. This can be done as described herein, typically using robot crawlers which automatically crawl, retrieve, and index information from e-commerce sites.

From operation 302, the method can proceed to operation 304, which determines whether there is a buyer for the item on the second site. A buyer would either purchase the item outright or bid on the item (if the e-commerce site is an auction site) with a bid higher than a minimum selling price.

If there is a buyer, then the method can proceed to operation 306, which purchases the item on the first site.

From operation 306, the method can proceed to operation 308, which ships the item to the buyer. The item can be shipped directly from the seller on the first site to the buyer from the second site. Alternatively, the item can be shipped from the seller on the first site to the purchaser (the performer of the method) of the item from the first site, whereupon the item can then be shipped from the purchaser to the buyer of the item on the second site.

In a further embodiment, a peer to peer market can be set up as well. The peer to peer market can allow users to buy and sell goods from each other without the transaction being processed through a main server.

Note that e-commerce sites as recited herein can signify any type of electronic market, including web merchants, auction sites, or any site where people of companies can buy and/or sell items.

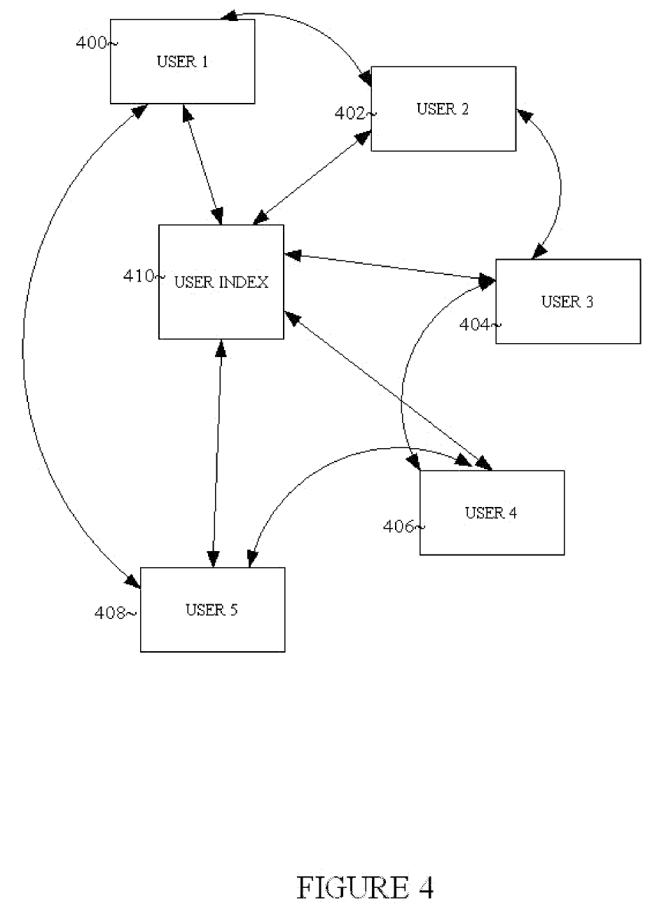

FIG. 4 is a block diagram illustrating a peer to peer market, according to an embodiment.

User 1 400, user 2 402, user 3 404, user 4 406, and user 5 408 are all connected via a peer to peer network, for example using the “Gnutella” file sharing protocol. A user index 410 can be used in order to store current users of the network. However, there is no main server, transactions can be completed peer to peer.

For example, user 1 can connect to the network and offers a red tie for sale. User 4 is searching for a red tie, and the search query is passed through other users until user 1 is united with user 4. User 1 and user 4 can then complete the sale at that point in time, and can use a third party payment processor.

Any of the embodiments described herein, including the arbitrage techniques, can be applied to a peer to peer market as well.

When a robot visits a web site, it can extract data by a method called “screen scraping.” This can be accomplished by downloading the html code associated with a page, and parsing any useful data from the code and storing it in a database. For example, a web site can be visited by a robot, all the links can be automatically clicked, and all of the relevant data from each page can be stored in a database. To some extent, this is how a standard search engine may work.

Many web sites have prohibitions against robot visitors. This can either be because robots slow a site down by using up its resources, or because the owner of the site does not wish their data to be electronically captured. Robots may be automatically detected. For example, if a robot visits too many pages too quickly (faster than a human can typically click links on a page), a site may be able to detect a robot visit and ban that robot (e.g., by banning the robot's IP address).

Therefore, it may be desirable for a robot to scrape a web site undetected by software running on the web site directed to detecting robots. This can be accomplished by giving the robot “human” qualities such that they don't show any characteristics that they are robots. This can be done in a number of ways. For example, the robot can delay before clicking each new page, as a human would. The time the screen scraping can occur can also be adjusted, so that it occurs during normal human hours (and not, for example, at 4 am in the location where the user's IP address can be geo-traced).

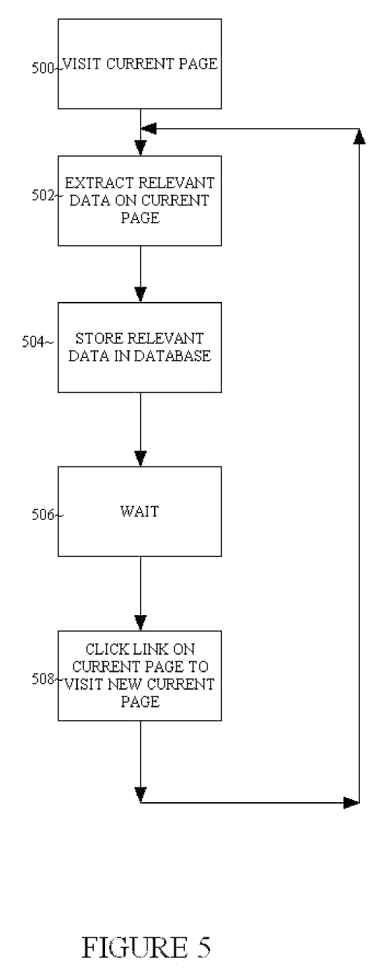

FIG. 5 is a flowchart illustrated an exemplary method of implementing screen scraping, according to an embodiment.

The method can start with operation 500, which visits a current page. This can be done as known in the art, such as transmitting a request for a web page to a server by a robot. In operation 500, the current page is also the initial page (for example a landing page) of a web site. Each initial page of different web sites can be identified by users and stored for later extraction of those pages/sites.

From operation 500, the method can proceed to operation 502, which extracts relevant data on the current page. This can be by downloading the html file for the page, then parsing the data to extract the useful information (such as the text, etc.) Image files can also be put through an optical character recognizer in order to determine any text that may be in image (e.g., JPG) format.

From operation 502, the method can proceed to operation 504, which stores the relevant data in a database.

From operation 504, the method can proceed to operation 506, which waits a period of time (e.g., 3 seconds). The waiting period corresponds to the period of time that a human would spend reading the page. The waiting time can fixed or also can be a random period of time (e.g., from 3 to 20 seconds chosen randomly).

From operation 506, the method can proceed to operation 508, which clicks a link on a current page to visit a new current page. In this manner, some or all web pages on a web site can be visited, screen scraped, and indexed and stored in a database. The delay in operation 504 can give the impression that a human is visiting the web site since a human would typically delay to read the current page before clicking links.

When a party is buying an item from an e-commerce site such as an auction site, the buyer has no guarantee that the item is not counterfeit, damages, or otherwise undesirable. In an embodiment, a user can verify the authenticity of an item online.

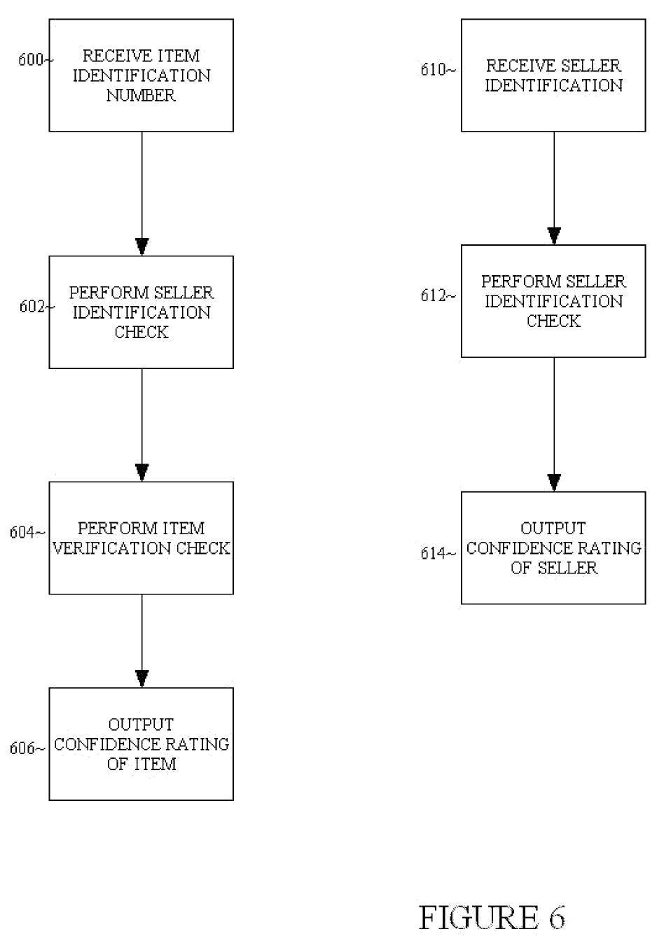

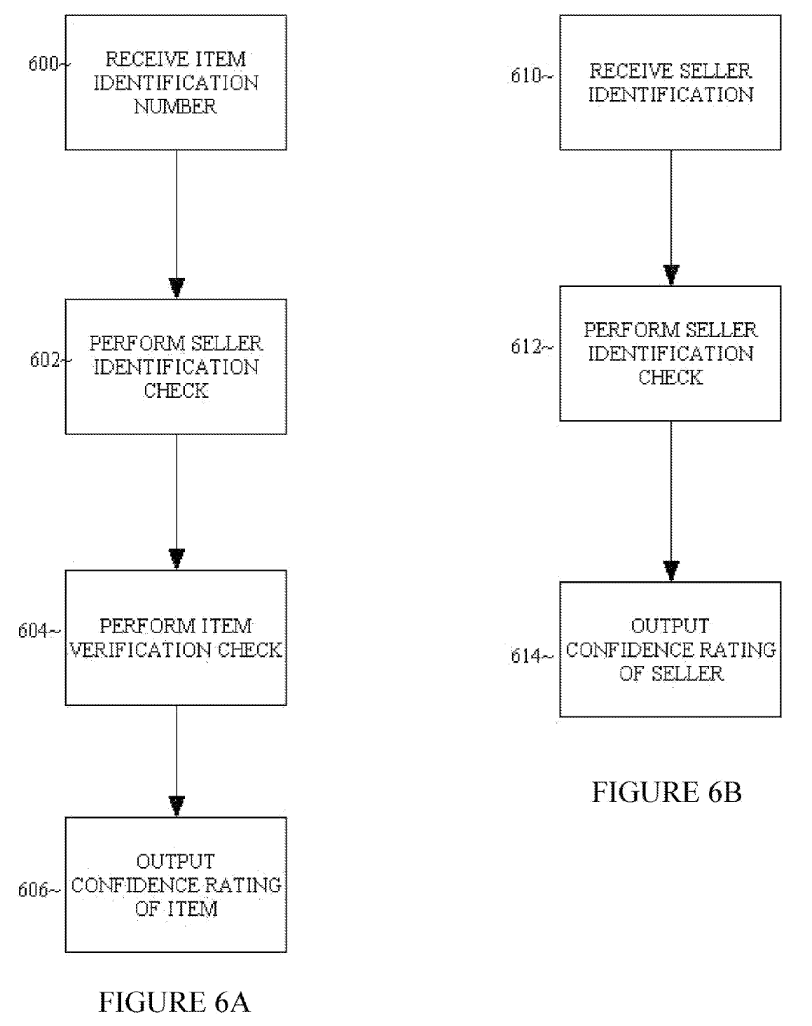

FIG. 6A is a flowchart illustrating an exemplary method of verifying an item, according to an embodiment.

The method begins with operation 600, wherein the system receives an identification number of the item in question. This can be done manually by the prospective purchaser typing in his name. This can also be done automatically, for example, when the purchaser bids on an item an item identification number can automatically be transmitted for analysis.

From operation 600, the method can proceed to operation 602, which performs a seller identification check. This checks the seller's integrity, and is described below in more detail (see operation 612). This operation can be optional and can be used as relevant information when performing the item verification check.

From operation 602, the method can proceed to operation 604, which performs an item verification check. This can be done in numerous ways. Rules can be applied to the item, and optionally the seller as well, in order to authenticate the item.

For example, the description of the item can be analyzed. If the analysis concludes that, from the description, the item cannot possibly be genuine, then the item will be identified as counterfeit (or alternatively as having a high level of suspicion). The system may be able to identify whether an item could not possibly be genuine by storing in a database all possible types of items by different manufactures. For example, if the ACME shoe company does not make boots, and a site is selling “ACME boots,” then the system can identify that this item must be counterfeit. The item verification check results in a confidence level of the item.

The results of the seller identification check in operation 602 can be incorporated into the determination if the confidence level of the item. For example, if data relating to the item has no suspicious data whatsoever, then the level of suspicion can be low. However, if the seller identification check determines that the seller has sold counterfeit goods in the past, then the level of suspicion of the item can be affected and changed to medium or high, depending on the rules used.

From operation 605, the method can proceed to operation 606, which outputs a confidence rating of the item based on the analysis performed in operation 602. Each item can, for example, have three different confidence levels (e.g., a red for high level of suspicion, yellow for moderate level of suspicion, and green for low level of suspicion).

A seller can also be identified (or verified) in order to determine whether this seller has a high likelihood of selling counterfeit or other prohibited goods.

FIG. 6B is a flowchart illustrating an exemplary method if verifying a seller, according to an embodiment.

The method can begin with operation 610, which receives a seller's identification. This can be the seller's user ID name or number, or any other tag used to uniquely identify each seller.

From operation 610, the method can proceed to operation 612, which performed a seller identification check. This can be performed by applying a set of rules to the seller in order to determine a level of confidence about the integrity of the seller and the seller's goods. For example, if the seller has been flagged in the past in the database as selling counterfeit (or other prohibited or undesirable items), then the seller may receive a high level of suspicion (e.g., a red warning level). If the seller is using an account that was recently opened, this can also raise a higher level of suspicion since sellers of undesirable items may continuously open new seller accounts. If the seller's description of goods matches to a previous seller's description of goods (or uses the same image file to picture their goods), it may be likely that the seller is really the previous seller trading under a new seller name, upon which data relating to the previous seller can be reviewed to determine that seller's integrity.

From operation 612, the method can proceed to operation 614, which outputs a confidence rating of the seller based on the analysis in operation 612.

In a further embodiment, auction kiting can be detected and addressed. Auction kiting is a scam wherein an innocent purchaser of a product receives his or her purchased product in the mail. The purchaser is unsatisfied with the product (e.g., it is counterfeit or otherwise undesirable) and contacts the seller to return it. The seller then tells the purchaser that the seller will accept the return and refund the purchaser's money, and provides an address for the purchaser to ship the product back to the seller. However, the seller has actually sold the same product again to another unsuspecting purchaser. The address that the seller provided to the first purchaser is actually the address of the second purchaser. The seller doesn't refund the first purchaser's money and now has received two payments (from both the first purchaser and the second purchaser) for the product which may even have little value. This scam can continue as the seller can continue to resell the same item to further unsuspecting purchasers.

It is noted that the methods described herein can be applied to any type of e-commerce site wherein goods are bought or sold via a computer communications network.

It is noted that any of the operations described herein can be performed in any sensible order. Further, any operation(s) may be optional. Any method described herein also includes hardware needed to implement the method, and also any software that can be stored on a computer readable storage medium which can instruct the hardware to perform the method.

The many features and advantages of the inventive concept are apparent from the detailed specification and, thus, it is intended by the appended claims to cover all such features and advantages of the inventive concept that fall within the true spirit and scope of the inventive concept. Further, since numerous modifications and changes will readily occur to those skilled in the art, it is not desired to limit the inventive concept to the exact construction and operation illustrated and described, and accordingly all suitable modifications and equivalents may be resorted to, falling within the scope of the invention.

What is claimed is:

1. A computer implemented method to display auction data, the method comprising:
robotically ascertaining a first price of a first item on a first e-commerce site and storing the first price in a database;
robotically ascertaining a second price of a second item on a second e-commerce site and storing the second price in the database, the second e-commerce site being different than the first e-commerce site, the second item being identical or similar to the first item;
comparing the first price and the second price, and determining that the first price is lower than the second price;
offering and selling the first item at a selling price to a purchaser, the selling price being higher than the first price;
purchasing the first item from the first e-commerce site; and
arranging shipment of the first item to the purchaser.

2. The method as recited in claim 1, wherein the offering and selling is performed at the second e-commerce site.

3. The method as recited in claim 1, wherein the offering and selling is performed at a third e-commerce site different from the first e-commerce site and the second e-commerce site.

4. The method as recited in claim 1, wherein the purchasing is performed after the first item is sold to the purchaser.

5. The method as recited in claim 1, wherein the purchasing is performed before the first item is sold to the purchaser.

6. The method as recited in claim 1, wherein the robotically ascertaining continuously crawls the first e-commerce site and the second e-commerce site.

7. The method as recited in claim 6, wherein the robotically ascertaining performs screen scraping in order to extract data from the first e-commerce site and the second e-commerce site.

8. The method as recited in claim 1, wherein the comparing is continuously performed while the database is being updated.

9. A computer implemented method to extract sales data from an e-commerce site, the method comprising:
automatically visiting a web page;
extracting data from the web page and storing the data in a database;
waiting an amount of time; and
automatically clicking a link on the web page to visit a new web page.

10. The method as recited in claim 9, wherein the amount of time is predetermined.

11. The method as recited in claim 9, wherein the amount of time is determined randomly.

12. The method as recited in claim 9, wherein the automatically visiting is limited to being performed during predetermined times of day.

13. A computer implemented method to authenticate an item for sale on an e-commerce site, the method comprising:
receiving an identification of an item;
performing a seller identification check;
performing an item verification check; and
determining a confidence level of the item based on the seller identification check and the item verification check.

14. The method as recited in claim 13, wherein the seller identification check queries a database to determine if the seller has previously sold prohibited items.

15. The method as recited in claim 13, wherein the item verification check comprises analyzing a description of the item to determine if the item is counterfeit, and if so, then the confidence level reflects that the item is counterfeit.

16. The method as recited in claim 15, wherein the analyzing determines if the description of the item is not manufactured by a manufacturer of the item, thereby indicating the item is counterfeit.
